(19) United States
(12) Patent Application Publication
(10) Pub. No.: US 2026/0056572 A1
(43) Pub. Date: Feb. 26, 2026

(54) CLOCK DISTRIBUTION WITH CLOCK OFFSETS

(71) Applicant: Tesla, Inc., Austin, TX (US)

(72) Inventors: Timothy Fischer, Denver, CO (US); Steven Wayne Butler, San Jose, CA (US); Raghuvir Ramachandran, Los Gatos, CA (US); Douglas R. Williams, Mountain View, CA (US); Atchyuth Gorti, Austin, TX (US); Aditya Jagirdar, Austin, TX (US); Anirudh Kadiyala, Austin, TX (US)

(21) Appl. No.: 19/103,380

(22) PCT Filed: Aug. 16, 2023
(86) PCT No.: PCT/US2023/072300

§ 371 Date: Feb. 12, 2025

Related U.S. Application Data
(60) Provisional application No. 63/373,024, filed on Aug. 19, 2022.

(51) Int. Cl. G06F 1/12; G06F 1/10

(52) U.S. Cl. CPC G06F 1/12; G06F 1/10

(57) ABSTRACT

Techniques for clock distribution with fixed clock offsets are disclosed. In one aspect, a clock distribution network for a node array includes clock distribution circuitry of a plurality of nodes. At least one of the nodes is configured to receive a clock signal, provide the clock signal to computing circuitry, and provide the clock signal to a neighboring node. There can be a unit of delay between the clock signal at the node and the neighboring node. In certain embodiments, the node can provide the clock signal to a first neighboring node in a same column and a second neighboring node in a same row, where the first and second neighboring nodes receive the clock signal with substantially the same delay.

### CROSS-REFERENCE TO RELATED APPLICATION

This application claims the benefit of U.S. Provisional Patent Application No. 63/373,024, filed Aug. 19, 2022, the disclosure of which is incorporated herein by reference in its entirety and for all purposes.

### BACKGROUND

### Technical Field

The present disclosure relates generally to clock distribution for electronic circuits and related systems and methods.

### Description of the Related Technology

A high density processing system can be constructed using an array of processing nodes. The nodes can communicate with neighboring nodes to perform processing tasks. Communication between nodes can use synchronous and/or asynchronous methods. A clock signal can be provided to each node so that the nodes can be synchronized, which can enable communication therebetween.

### SUMMARY OF CERTAIN INVENTIVE ASPECTS

The innovations described in the claims each have several aspects, no single one of which is solely responsible for its desirable attributes. Without limiting the scope of the claims, some prominent features of this disclosure will now be briefly described.

In one aspect, there is provided an integrated circuit with a clock distribution network for a computational node array, comprising: a node array comprising a plurality of nodes, the plurality of nodes comprising a first node and a second node that abuts the first node, wherein the first node comprises clock distribution circuitry configured to: receive a clock signal, provide the clock signal to computing circuitry of the first node, and provide the clock signal to the second node, wherein the clock signal is delayed by a unit of delay in the second node relative to the first node.

In certain embodiments, the first node is configured to: receive the clock signal from two upstream nodes, and provide the clock signal to two downstream nodes with the unit of delay.

In certain embodiments, the nodes are arranged into rows and columns, and the node array is configured to propagate the clock signal through the node array such that nodes along a diagonal of the node array have substantially a same timing delay for the clock signal.

In certain embodiments, the first node comprises: a first input clock wire configured to receive the clock signal from a first upstream node; a second input clock wire configured to receive the clock signal from a second upstream node; a first output clock wire configured to provide the clock signal to a first downstream node with the unit of delay; and a second output clock wire configured to provide the clock signal to a second downstream node with the unit of delay.

In certain embodiments, the first node further comprises: a first inverter coupled between the first input clock wire and the computing circuitry, the first inventor also coupled between the second input clock wire and the computing circuitry; a second inverter; and a third inverter, the second inventor and the third inventor coupled between the first input clock wire and the first output clock wire, the second inverter and the third inverter also coupled between the second input clock wire and thee first output clock wire.

In certain embodiments, the first upstream node is located north of the first node, the second upstream node is located west of the first node, the first downstream node is located east of the first node, and the second downstream node is located south of the first node.

In certain embodiments, the node array comprises a plurality of compute nodes and a plurality of globals nodes.

In certain embodiments, the integrated circuit further comprises: a clock management circuit comprising: a clock generation circuit configured to receive a system clock signal and generate a functional clock signal; a first multiplexer configured to receive the functional clock signal and an alternative clock signal and selectively output one of the functional clock signal and the alternative clock signal; and a second multiplexer configured to receive the output from the first multiplexer and a test clock signal, and output one of the output from the first multiplexer and the test clock signal to a root node of the node array.

In certain embodiments, the integrated circuit further comprises: a multiplexer configured to receive a functional clock signal from a clock generation circuit and a test clock signal, and output one of the functional clock signal and the test clock signal to a root node of the node array as the clock signal.

In certain embodiments, the node array has a strapped H-tree clock distribution topology.

In another aspect, there is provided a node array with mesochronous clock distribution, comprising: a node array comprising a plurality of nodes arranged in rows and columns, wherein the node array comprises a root node at a corner of the node array, wherein the root node is configured to receive a clock signal from external to the node array, to provide the clock signal to a first neighboring node in a same column of the node array with a unit of delay, and to provide the clock signal to a second neighboring node in a same row of the node array with the unit of delay, and wherein nodes along a diagonal of the node array receive the clock signal with a same number of unit clock delays.

In certain embodiments, the root node comprises computing circuity, and the root node is further configured to provide the clock signal to the computing circuitry.

In certain embodiments, the plurality of nodes comprise a first node configured to: receive the clock signal from two upstream nodes, and provide the clock signal to two downstream nodes with a one unit clock delay.

In certain embodiments, the plurality of nodes comprise a first node comprising: a first input clock wire configured to the clock signal from a first upstream node; a second input clock wire configured to receive the clock signal from a second upstream node; a first output clock wire configured to provide the clock signal to a first downstream node; and a second output clock wire configured to provide the clock signal to a second downstream node.

In certain embodiments, the first node further comprises a first inverter coupled between the first input wire and a computing circuitry of the first node, the first inventor also coupled between the second input wire and the computing circuitry.

In certain embodiments, the first upstream node is located north of the first node, the second upstream node is located west of the first node, the first downstream node is located east of the first node, and the second downstream node is located south of the first node.

In certain embodiments, the node array further comprises: a multiplexer configured to receive a functional clock signal from a clock generation circuit and a test clock, and output one of the functional clock signal and the test clock to the root node as the clock signal.

In certain embodiments, the node array has a strapped H-tree clock distribution topology.

In yet another aspect, there is provided a method of clock distribution in a node array, comprising: receiving a clock signal at a first node of the node array; providing the clock signal to computing circuitry of the first node; and providing the clock signal to a neighboring node of the node array, wherein the neighboring node abuts the first node, and wherein the clock signal has a unit of delay in the neighboring node relative to in the first node.

In certain embodiments, the method further comprises: receiving, at the first node, the clock signal from two upstream nodes with the unit of delay relative to the two upstream nodes, wherein one of the two upstream nodes is in a same row of the node array as the first node, and wherein an other of the two upstream nodes is in a same column of the node array as the first node; and providing the clock signal to two downstream nodes with the unit of delay relative to the first node.

For purposes of summarizing the disclosure, certain aspects, advantages and novel features of the innovations have been described herein. It is to be understood that not necessarily all such advantages may be achieved in accordance with any particular embodiment. Thus, the innovations may be embodied or carried out in a manner that achieves or optimizes one advantage or group of advantages as taught herein without necessarily achieving other advantages as may be taught or suggested herein.

### BRIEF DESCRIPTION OF THE DRAWINGS

FIG. 1 is a schematic block diagram of an example chip in accordance with aspects of this disclosure.

FIG. 2A is a schematic diagram of a clock distribution network according to an embodiment.

FIG. 2B is a schematic diagram of the clock management unit (CMU) in accordance with aspects of this disclosure.

FIG. 2C illustrates an example implementation of the clock distribution circuitry within an example node of the node array of FIG. 2A.

FIG. 2D illustrates an alternative example implementation of the clock distribution circuitry within an example node of the node array of FIG. 2A.

FIG. 3 is a node clock-level map associated with an example node array such as the node array of FIG. 2A.

FIG. 4A is a schematic diagram of a clock distribution network having a node array with a 2D distributed strapped H-tree clock distribution topology according to an embodiment of this disclosure.

FIG. 4B illustrates an example implementation of the clock distribution circuitry within an example node of the node array of FIG. 2A.

FIG. 4C illustrates the node array of FIG. 4A rearranged to illustrate the strapped H-tree topology of the node array.

### DETAILED DESCRIPTION OF CERTAIN EMBODIMENTS

The following description of certain embodiments presents various descriptions of specific embodiments. However, the innovations described herein may be embodied in a multitude of different ways, for example, as defined and covered by the claims. In this description, reference is made to the drawings where like reference numerals may indicate identical or functionally similar elements. It will be understood that elements illustrated in the figures are not necessarily drawn to scale. Moreover, it will be understood that certain embodiments may include more elements than illustrated in a drawing and/or a subset of the elements illustrated in a drawing. Further, some embodiments may incorporate any suitable combination of features from two or more drawings.

This disclosure provides a new way of distributing a clock signal across a chip, so that the clock circuitry can be modularly constructed by assembling identical sub-pieces of the entire clock distribution circuitry. The clock distribution circuitry disclosed herein can save area, simplify design, and reduce power. Noise can be reduced relative to clock distribution for synchronous clock signals. Embodiments disclosed herein can also significantly reduce supply rail noise in certain frequency ranges, which can help improve chip electrical robustness and further reduce power dissipation.

Traditionally, a clock signal is constructed and routed at the top level of a chip, which incurs effort, area, and power costs on the design. In such a case, the clock distribution is a custom design at the top level of the chip. One way to do this is to route the clock signal in channels between sub-blocks. This can break up the design and consume area. Another way is to push the top-level clock down into sub-blocks. This can slow the design process and cause identical portions of the design to be forked, where unique copies are created. Traditional approaches can result in a clock signal that arrives at all receivers at approximately the same time. Then circuits can operate in lock step.

In clock distribution networks disclosed herein, a clock arrives at various receivers at different times. The clock signal can be distributed through a 2-dimensional (2D) array of nodes such that the clock signal arrives at different nodes with different timing offsets. Because of the clock distribution structure, the arrival times can be grouped in contours or waves across a die. At a local level, circuitry of a node can operate in lock step. More globally, circuitry in different nodes of a node array can operate with timing offsets relative to each other. Peak current from a power grid can be reduced by having different nodes perform computing with timing offsets relative to each other. Quality of a power supply signal can also be improved by such computing. Computing circuitry can be designed to handle the arrival time differences of the clock signal.

Clock distribution networks disclosed herein can simplify the top-level design of the chip and the clock circuitry construction. Clocking with fixed offsets can be referred to as mesochronous clocking. Embodiments disclosed herein allow a mesochronous clock network to be built modularly of instances of a common sub-section design. The clock signals of such a network can be locally low-skew and mesochronous at a coarser level.

The clock distribution disclosed herein can be applied to any suitable chip. In certain applications, clock distribution disclosed herein can be applied to chips that each include an array of smaller compute nodes. The compute nodes can be referred to processors or cores. In this way, the clock signals can form an arrival-time wave across the array. Each compute node can receive a low skew clock signal. A compute node of the array can be designed with only the interface to neighbor compute nodes accounting for the arrival-time difference (skew) of the mesochronous clock phases. A chip with a clock distribution network disclosed herein can have a 35 phase mesochronous clock or a 41 phase mesochronous clock, for example. The clock distribution described herein can be used in a node array that is square (equal rows and columns) or in a node array that is rectangular with a different number of rows than columns.

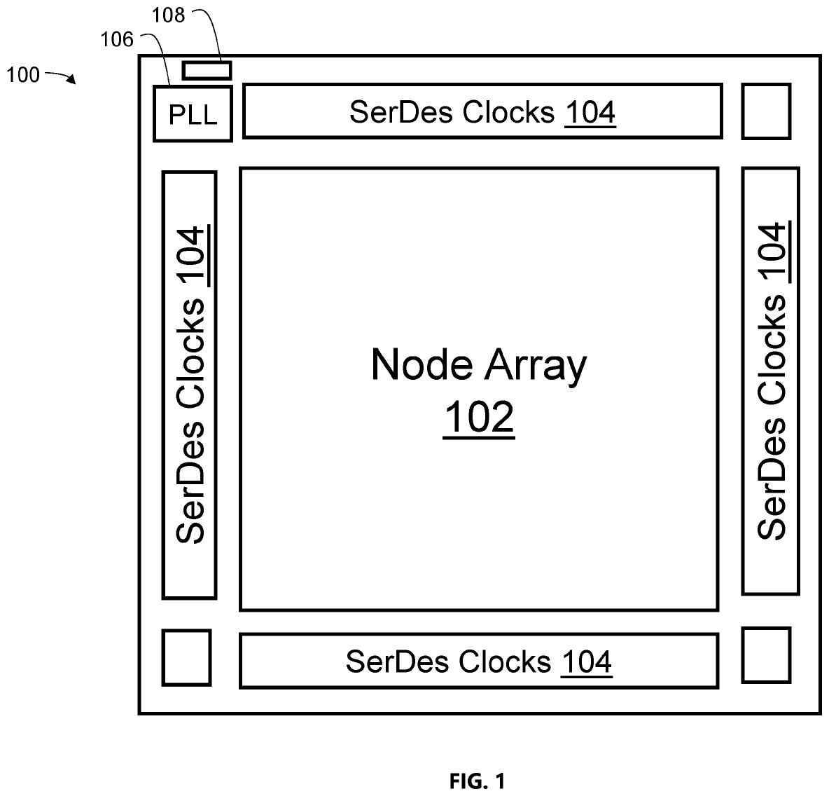

FIG. 1 is a schematic block diagram of an example chip 100 in accordance with aspects of this disclosure. The chip 100 can be an integrated circuit die. The chip 100 can include a node array 102 (also referred to as a computational node array) with distributed clocking, one or more Serializer/Deserializer (SerDes) clock blocks 104, a clock generator 106, and a clock controller 108. The SerDes clock blocks 104 can interface with other chips 100 forming an array of chips 100. In certain application instances, the node array 102 can be included on a chip 100 in a system-on-wafer system, an array of chips 100 on a printed circuit board, or the like. In certain applications, the node array 102 of FIG. 1 can be implemented on a system on a wafer that is packaged with a wafer-level packaging structure. As shown in the embodiment of FIG. 1, the clock generator 106 can be implemented external to the node array 102. In some embodiments, the clock generator 106 can include a phase-locked loop (PLL). The clock generator 106 can be arranged to provide a clock signal to a compute node at a corner of the node array 102. The clock controller 108 can also be implemented outside of the node array 102. The nodes within the node array 102 can include node to node interfaces that can be configured to communicate synchronously. A core to Serializer/Deserializer (SerDes) interface can be asynchronous.

In the node array 102 with distributed clocking of FIG. 1, each node can be an instance of a computing circuit (also referred to as a processing core or compute node). In certain applications, most of the nodes can be implemented as instances of a computing circuit, and one or more of the nodes can be implemented as instances of a different circuit. Each node of the node array 102 can include an instance of substantially the same clock distribution circuitry even if other circuitry of at least some of the nodes is different than that of other nodes. In the node array 102, nodes can be tiled and abutted. For example, each node of the node array 102 can be self-contained and interconnected to adjacent node(s)). At the same time, the node array 102 can be implemented without the use of top-level wires or gates. Accordingly, nodes can be configured to communicate with neighboring nodes with lower-level wires over short connections. In some embodiments, the nodes of the node array 102 can be stepped without mirroring or rotation. In certain implementations, the nodes can be aligned to the grid pitch of the power supply lines (V_{DD}/V_{SS}). For example, the height and width of each node can be multiples of the power supply grid pitch. The power supply grid pitch can further be aligned to a bump pitch.

Each node of the node array 102 can include an instance of substantially the same clock distribution circuitry. The nodes can be designed such that output clock wires of a node are aligned with the input clock wires of its neighboring nodes. The nodes can be stepped and tiled in the node array such that clock output wires align with and electrically connect with clock input wires of neighboring nodes that are arranged downstream to receive the clock signals. With such electrical connections, the node array can be implemented without channels or top-level wiring for clock distribution. In certain embodiments, fanouts of the clock distribution circuitry can be balanced for inverters.

As described herein, the clock signal received at a root node can propagate from the root node to two neighboring nodes with one unit of delay. The root node can be located at a corner of the node array 102. The unit of delay can be a fixed offset for a given node array. The unit of delay can correspond to a delay from buffering the clock signal (e.g., using inverters) and the wire delay associated with the clock signal propagating to its neighboring node(s).

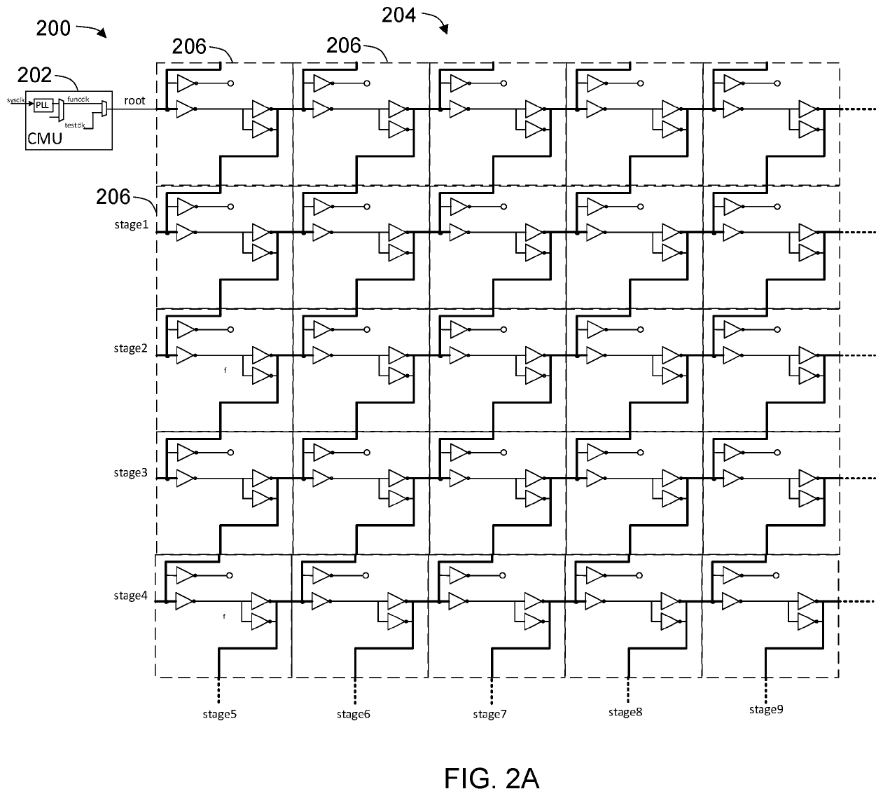

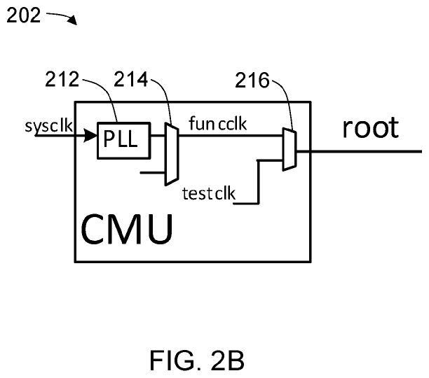

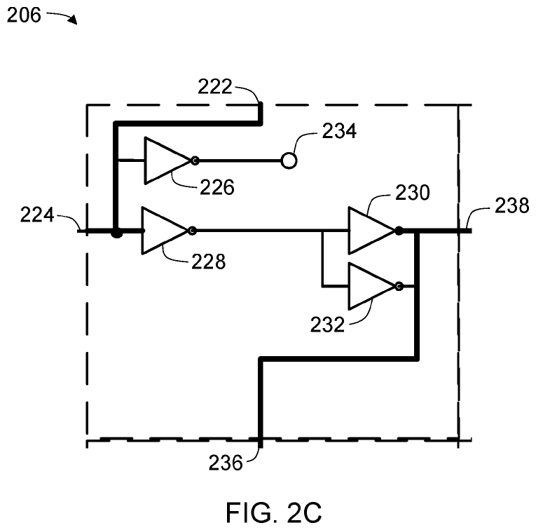

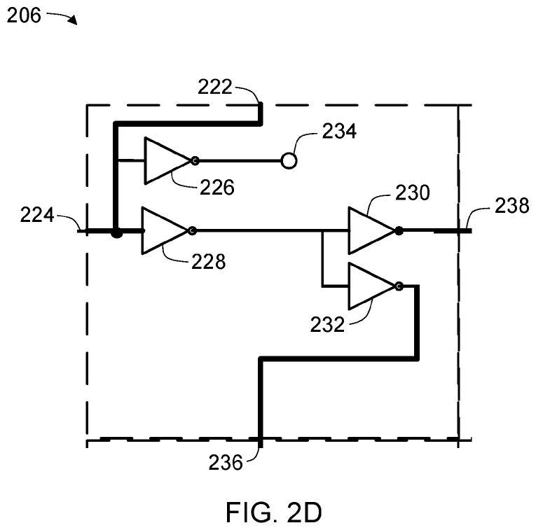

One of the two neighboring nodes can be located in the same row as the root node and the other of the two neighboring nodes can be located in the same column as the root node. The neighboring nodes abut the root node. As one example, the neighboring nodes are to the south and the east of the root node in FIG. 2A. The clock signal continues to propagate with one more unit of delay to neighboring nodes to the south and east from the two neighboring nodes of the root node in the node array in this example. Such clock signal propagation continues through the clock distribution network in the node array 102 until the clock signal reaches the node of the node array 102 at an opposite corner from the root node. In this example, a signal that is routed from an originating node that generates the signal to a neighboring node that is north or west of the originating node can travel upstream and lose one unit delay in a node array 102, and a signal that is routed from an originating node to a neighboring node that is south or east can travel downstream and gain one unit delay in a node array 102. Signals traveling upstream can be routed faster than signals traveling downstream to account for the unit delay and meet setup and hold time specifications.

FIG. 2A is a schematic diagram of a clock distribution network 200 according to an embodiment. The clock distribution network 200 includes a clock management unit (CMU) 202 and clock distribution circuitry of a node array 204 (also referred to as a clock distribution node array) of nodes 206. Each node 206 includes an instance of clock distribution circuitry for clock distribution within the node array 204. In the embodiment of FIG. 2A, the clock distribution network 200 has a 2D distributed strapped H-tree topology. The CMU 202 is configured to output a clock signal, which is received at a root node 206 of the node array 204.

FIG. 2B is a schematic diagram of the CMU 202 in accordance with aspects of this disclosure. The CMU 202 includes a PLL 212, a first multiplexer 214, and a second multiplexer 216. The PLL 212 is configured to receive a system clock signal sysclk and generate a functional clock signal funcclk. The first multiplexer 214 is configured to receive the functional clock signal funcclk at a first input and an alternative clock signal at a second input and to selectively output one of the functional clock signal funcclk and the alternative clock signal at an output of the first multiplexer 214. Depending on the embodiment, the alternative clock signal can include one or more of the following: a bypassed clock signal, a reference clock signal generated on-or off-chip 100, a divided clock signal, or any other suitable clock signal. The second multiplexer 216 is configured to receive the clock output signal from the first multiplexer 214 at a first input and a test clock signal testclk at a second input and selectively output one of the clock output signal from the first multiplexer 214 or the test clock signal testclk at an output of the second multiplexer 216. Accordingly, the CMU 202 can be configured to selectively output one of: the functional clock signal funcclk, the test clock signal, or the alternative clock signal to the root node of the node array 204. The CMU 202 can provide a clock signal to the clock distribution network 200 for operating and/or testing a chip 100. For example, the CMU 202 can provide the test clock signal testclk to the clock distribution for testing the chip 100. As another example, the CMU 202 can provide the functional clock signal funcclk for typical operation of the chip 100.

With reference to FIG. 2A, the root can be located at the input to a node 206 in a corner of the node array 204. For example, the root can be located at the input to a node 206 at the northwest or upper left corner of the node array 204 illustrated in FIG. 2A. In other embodiments, the root can be the input to another corner node 206 of a node array 204 when clock signals propagate in a different direction along a row and/or column of nodes. The node 206 that receives a clock signal from external to the node array 204 can be referred to as a root node 206.

Referring back to FIG. 2A, the clock distribution network 200 can be implemented with a node array 204. The node array 204 illustrated in FIG. 2A is an example of the node array 102 with distributed clocking of FIG. 1. In certain embodiments, each node 206 can be an instance of a computing circuit. In certain applications, most of the nodes 206 include instances of a computing circuit and one or more of the remaining nodes 206 include instances of a different circuit, such as a globals node. Globals nodes may refer to nodes 206 that do not include circuitry for performing processing tasks. In some implementations, compute nodes and globals nodes may both include communication interfaces to enable communication with neighboring nodes 206. In some implementations, the communication interfaces for compute nodes may be the same as the communication interfaces for globals nodes.

In certain embodiments, each node 206 of the node array 204 can include an instance of the same clock distribution circuitry even if the other circuitry of one or more of the nodes 206 is different than that of other nodes 206. In the node array 204, nodes 206 can be tiled and abutted. At the same time, the node array 204 may be implemented without any top-level wires or gates. Accordingly, nodes 206 can communicate with neighboring nodes 206 with lower-level wires over short connections. The nodes 206 of the node array 204 can be stepped without mirroring or rotation. The nodes 206 can also be aligned to a grid pitch of power supply (VDD/VSS) lines. For example, the height and width of each node 206 can be a multiple of the power supply grid pitch. In some embodiments, the power supply grid pitch can further be aligned to a bump pitch.

As shown in FIG. 2A, each node 206 can include an instance of substantially the same clock distribution circuitry. FIG. 2C illustrates an example implementation of the clock distribution circuitry within an example node 206 of the node array 204 of FIG. 2A. With reference to FIGS. 2A and 2C, the clock distribution circuitry includes a first input clock wire 222, a second input clock wire 224, a first inverter 226, a second inverter 228, a third inverter 230, a fourth inverter 232, a clock tap point 234, a first output clock wire 236, and a second output clock wire 238.

The clock distribution circuitry for each of the nodes 206 is designed such that output clock wires 236 and 238 of a node 206 are aligned with input clock wires 222 and 224 of neighboring nodes 206. The nodes 206 can be stepped and tiled in the node array 204 such that the output clock wires 236 and 238 align with and electrically connected with the input clock wires 222 and 224 two of the neighboring nodes 206. Using these electrical connections, the node array 204 can be implemented without the use of channels or top-level wiring for the distribution of the clock.

Returning to FIG. 2C, the input wires 222 and 224 can receive an input clock signal from two of the neighboring nodes 206. For example, the first input clock wire 222 receives an input clock signal from the neighboring node 206 above the current node 206 while the second input clock wire 224 receives an input clock signal from the neighboring node 206 to the left of the current node 206. The first and second input clock wires 222 and 224 provide the clock signal to the first and second inverters 226 and 228. The first inverter 226 inverts the clock signal and provides the inverted clock signal to the clock tap point 234, which is then provided to the primary circuitry of a corresponding node of the computational node array 102 (e.g., the computing circuit or globals circuit in certain embodiments).

The second inverter 228 inverts the clock signal and provides the inverted clock signal to the third and fourth inverters 230 and 232. Each of the third and fourth inverters 230 and 232 inverters the inverted clock signal and outputs the resulting clock signal to the first and second output clock wires 236 and 238. The first and second output clock wires 236 and 238 output the clock signal to the neighboring nodes 206 to the right and below the current node 206.

Referring back to FIG. 2A, the clock signal received at the root node 206 propagates from the root node 206 to its two neighboring nodes below and to the right with one unit of delay. The unit of delay can be a fixed offset for the entire node array 204. In some implementations, the unit of delay can correspond to a delay from buffering the clock signal (e.g., via the inverters 228-232) combined with the wire delay associated with the clock signal propagating to the downstream neighboring nodes 206. In FIG. 2A, one of the downstream neighboring nodes 206 is in the same row as and to the right of the root node 206 and the other of the downstream neighboring nodes 206 is in the same column and below as the root node 206. In other words, the neighboring nodes 206 can be located to the south and the east of the root node 206.

The clock signal will continue to propagate with one more unit of delay to neighboring nodes 206 to the south and as the clock signal traverses the entire node array 204 of FIG. 2A. Such clock signal propagation continues through the clock distribution network until the clock signal reaches the node 206 of the node array 204 at an opposite corner from the root node 206 (e.g., on the bottom right of the figure).

As the clock signal propagates through the node array 204, nodes 206 in the node array 204 can receive clock signals with substantially the same delay from two other neighboring nodes 206. A recombinant mesh topology can combine the two clock signals received from two neighboring nodes 206 at a given node 206 of the node array 204. For example, in FIG. 2C, the clock signals received via the first input clock wire 222 and the second input clock wire 224 can be combined and received at each of the first inverter 226 and the second inverter 228. In some embodiments, the clock signal is combined by directly connecting the first input clock wire 222 and the second input clock wire 224 together. Other implementations for providing a recombinant mesh topology are also possible.

The clock distribution circuitry disclosed herein allows for flexible array structures, which support a wide range of array designs. For example, a node array 204 can be substantially square with the same number of rows and columns. Alternatively, a node array 204 can be substantially rectangular with a different number of rows than columns. The clock distribution circuitry disclosed herein also provides for relatively simple restructuring of an array with respect to the clock, which can also allow for relatively late schedule design decisions regarding node array shapes. In contrast, array sizes and shapes with other clock distribution networks are typically expensive decisions to defer due to the amount of clock design time involved. However, in certain cases such late decisions can result in overall chip design optimization and, thus, can be desirable.

FIG. 2D illustrates an alternative example implementation of the clock distribution circuitry within an example node 206 of the node array 204 of FIG. 2A. The node 206 of FIG. 2D is similar to the node 206 illustrated in FIG. 2C with the exception of the outputs of the third and fourth inverters 230 and 232, respectively, are not coupled with each other. Accordingly, the third inverter 230 independently provides the output clock signal to the first output clock wire 238, while the fourth inverter 232 independently provides the output clock signal to the second output clock wire 236.

In summary, the clock distribution network 200 can be implemented such that each of the nodes 206 is configured to receive a clock signal from at least one neighboring node (or the CMU 202 in the case of the root node 206), provide the clock signal to a corresponding node of the computational node array (e.g., via the clock tap point 234), and provide the clock signal to a neighboring clock distribution node 206 when arranged adjacent to a downstream clock distribution node 206. For example, for nodes 206 that are arranged adjacent to four neighboring nodes 206, the node 206 can receive the clock signal from two upstream clock distribution nodes, and provide the clock signal to two downstream clock distribution nodes with a unit delay.

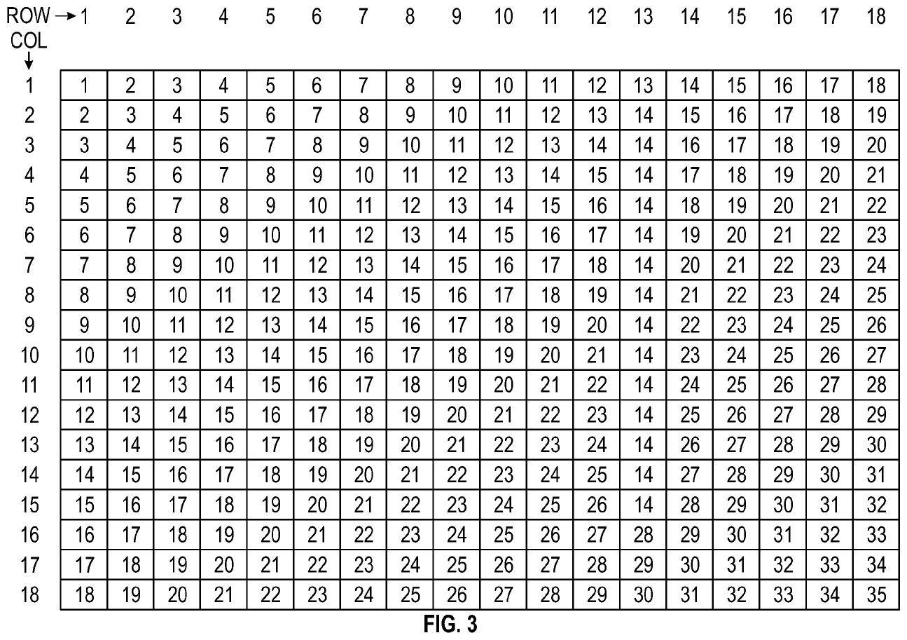

FIG. 3 is a node clock-level map associated with an example node array such as the node array 204 of FIG. 2A. The example node array 204 has 18 rows and 18 columns. With 18 rows and 18 columns, there can be 324 nodes. As another example, a node array 204 can include 360 nodes arranged in rows and columns. Nodes 206 of the node array 204 can have clock distribution circuitry corresponding to that of FIG. 2C or 2D, for example. This clock map illustrates the number of unit delays for a clock signal output for a node 206 of the node array 204. For example, the root node 206 has 1 unit delay. The two nodes 206 neighboring the root node 206 have 2 unit delays. The nodes 206 on diagonals from southwest to northeast can have the same unit delays. Using the clock distribution circuitry described herein, the unit delays can be fixed offsets. The nodes 206 along these diagonals can receive clock signals having substantially the same timing delay. These diagonals can be referred to as phases or waves. The phases correspond to different clock signal arrival times in the nodes 206. The clock signal distribution corresponding to the map of FIG. 3 can implement a 35 phase mesochronous clock. The number of phases of a mesochronous clock signal for a node array with clock distribution circuitry described herein can be the number of rows plus the number of columns minus one.

In certain embodiments, rather than the clock signal traversing the node array 204 with waves that are formed along a diagonal of the node array 204, the clock distribution network 200 can be configured to generate waves that traverse the node array 204 in the row or column direction. For example, rather than outputting the clock signal to the south and the east, each nodes 206 may output the clock signal to either the south or the east. In this way, the clock signal may propagate in waves that travel to the south or to the east. However, aspects of this disclosure are not limited to a particular direction of travel for the clock signals, and the clock signals can propagate along other diagonals and/or to the north or west.

The offsets of FIG. 3 can be accounted for when routing signals between nodes 206. A signal that is routed from an originating node that generates the signal to a node that is north or west can travel upstream and lose one unit delay in a node array 204 corresponding to FIG. 3. A signal that is routed from an originating node to a node that is south or east can travel downstream and gain one unit delay in a node array 204 corresponding to FIG. 3. Signals traveling upstream can be routed faster than signals traveling downstream to account for the unit delay and meet setup and hold time specifications.

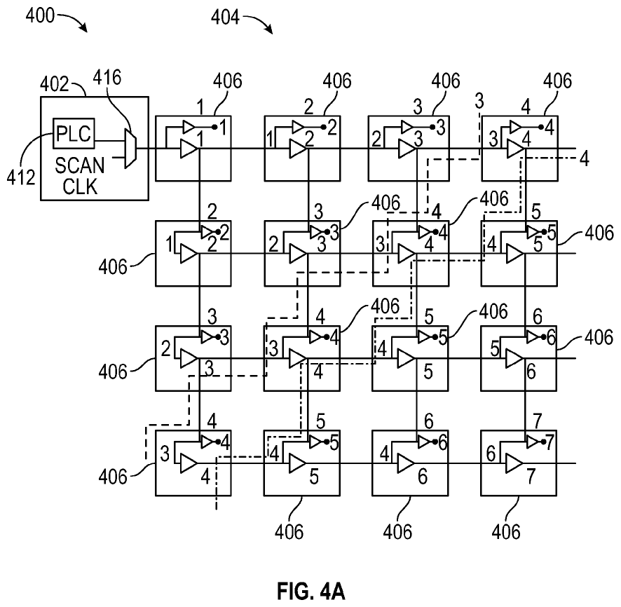

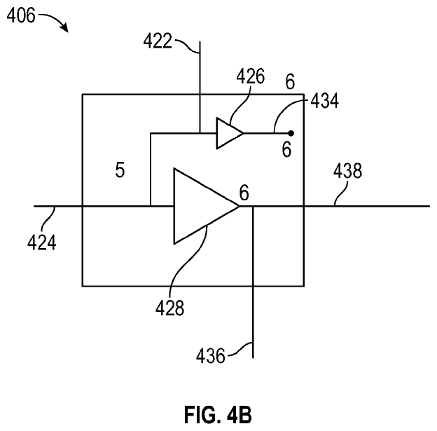

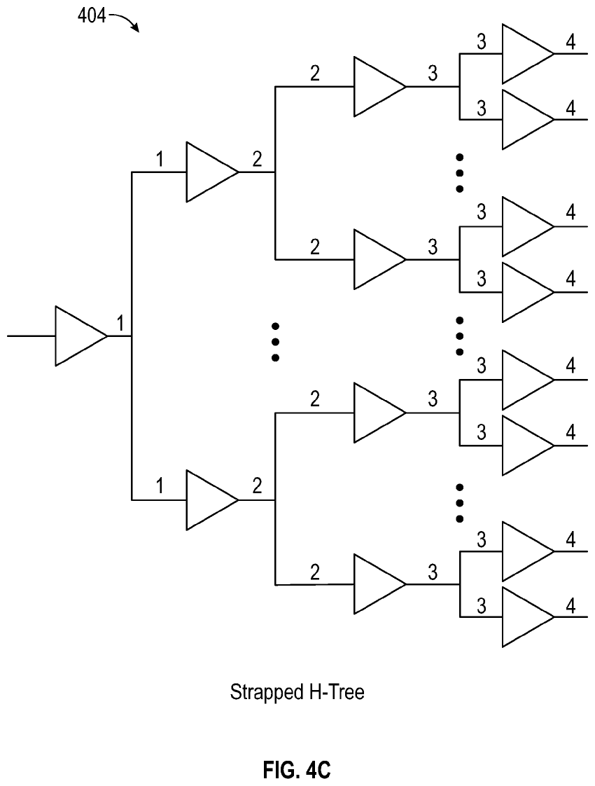

FIG. 4A is a schematic diagram of a clock distribution network 400 having a node array 404 with a 2D distributed strapped H-tree clock distribution topology according to an embodiment of this disclosure. FIG. 4B illustrates an example implementation of the clock distribution circuitry within an example node 406 of the node array 404 of FIG. 2A. FIG. 4C illustrates clock distribution circuitry of the node array 404 of FIG. 4A rearranged to illustrate the strapped H-tree topology of the node array 404.

The clock distribution network 400 includes a CMU 402 and a node array 404. The CMU 402 includes a PLL 412 and a multiplexer 416. The PLL 412 is configured to receive a system clock signal and generate a functional clock signal. The multiplexer 416 is configured to receive the functional clock signal and a scan clock signal and selectively provide one of the functional clock signal and the scan clock signal to a root node 406 of the node array 404. The node array 404 includes a plurality of nodes 406. Each of the nodes 406 includes a first input clock wire 422, a second input clock wire 424, a first inverter 426, a second inverter 428, a clock tap point 434, a first output clock wire 438, and a second output clock wire 436 as illustrated in FIG. 4B.

The input wires 422 and 424 can receive an input clock signal from two of the neighboring nodes 406. For example, the first input clock wire 422 receives an input clock signal from the neighboring node 406 above the current node 406 while the second input clock wire 424 receives an input clock signal from the neighboring node 406 to the left of the current node 406. For the case of the node 406 being the root node, the clock signal is received from the CMU 402. The first and second input clock wires 422 and 424 provide the clock signal to the first and second inverters 426 and 428. The first inverter 426 inverts the clock signal and provides the inverted clock signal to the clock tap point 434, which is then provided to the primary circuit of the node 406 (e.g., the computing circuit or globals circuit in certain embodiments).

The second inverter 428 inverts the clock signal and provides the inverted clock signal to the first and second output clock wires 436 and 438. The first and second output clock wires 436 and 438 output the clock signal to the neighboring nodes 406 to the right and below the current node 406.

As illustrated in FIGS. 4A-4C, each node 406 along a diagonal of the node array 404 can receive a clock signal with a same number of unit delays in the 2D distributed strapped H-tree clock distribution network. For example, there are four nodes 406 of the node array 404 along a diagonal that receive a clock signal with 3 unit delay from the clock root. As another example, there are three nodes 406 along another diagonal of the node array 404 that receive a clock signal with a 4 unit delay from the root node 406. The nodes 406 along these diagonals can receive clock signals with the same number of unit delays from two neighboring nodes 406 and combine the two received clock signals 406.

The node arrays disclosed herein can be implemented in a variety of processing systems. Such processing systems can used in and/or specifically configured for high performance computing and/or computationally intensive applications, such as neural network training, neural network inference, machine learning, artificial intelligence, complex simulations, or the like. In some applications, the processing system can be used to perform neural network training. For example, such neural network training can generate data for an autopilot system for vehicle (e.g., an automobile), other autonomous vehicle functionality, or Advanced Driving Assistance System (ADAS) functionality.

### Conclusion

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosed air vent assembly. It is to be understood that the forms of disclosure herein shown and described are to be taken as representative embodiments. Equivalent elements, materials, processes or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense, and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other. Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application.

What is claimed is:

1. An integrated circuit with a clock distribution network for a computational node array, comprising:
a node array comprising a plurality of nodes, the plurality of nodes comprising a first node and a second node that abuts the first node,
wherein the first node comprises clock distribution circuitry configured to:
receive a clock signal,
provide the clock signal to computing circuitry of the first node, and
provide the clock signal to the second node, wherein the clock signal is delayed by a unit of delay in the second node relative to the first node.

2. The integrated circuit of claim 1, wherein the first node is configured to:
receive the clock signal from two upstream nodes, and
provide the clock signal to two downstream nodes with the unit of delay.

3. The integrated circuit of claim 1, wherein:
the nodes are arranged into rows and columns, and
the node array is configured to propagate the clock signal through the node array such that nodes along a diagonal of the node array have substantially a same timing delay for the clock signal.

4. The integrated circuit of claim 1, wherein the first node comprises:
a first input clock wire configured to receive the clock signal from a first upstream node;
a second input clock wire configured to receive the clock signal from a second upstream node;
a first output clock wire configured to provide the clock signal to a first downstream node with the unit of delay; and
a second output clock wire configured to provide the clock signal to a second downstream node with the unit of delay.

5. The integrated circuit of claim 4, wherein the first node further comprises:
a first inverter coupled between the first input clock wire and the computing circuitry, the first inventor also coupled between the second input clock wire and the computing circuitry;
a second inverter; and
a third inverter, the second inventor and the third inventor coupled between the first input clock wire and the first output clock wire, the second inverter and the third inverter also coupled between the second input clock wire and thee first output clock wire.

6. The integrated circuit of claim 4, wherein:
the first upstream node is located north of the first node,
the second upstream node is located west of the first node,
the first downstream node is located east of the first node, and
the second downstream node is located south of the first node.

7. The integrated circuit of claim 1, wherein the node array comprises a plurality of compute nodes and a plurality of globals nodes.

8. The integrated circuit of claim 1, further comprising:
a clock management circuit comprising:
a clock generation circuit configured to receive a system clock signal and generate a functional clock signal;
a first multiplexer configured to receive the functional clock signal and an alternative clock signal and selectively output one of the functional clock signal and the alternative clock signal; and
a second multiplexer configured to receive the output from the first multiplexer and a test clock signal, and output one of the output from the first multiplexer and the test clock signal to a root node of the node array.

9. The integrated circuit of claim 1, further comprising:
a multiplexer configured to receive a functional clock signal from a clock generation circuit and a test clock signal, and output one of the functional clock signal and the test clock signal to a root node of the node array as the clock signal.

10. The integrated circuit of claim 1, wherein the node array has a strapped H-tree clock distribution topology.

11. A node array with mesochronous clock distribution, comprising:
a node array comprising a plurality of nodes arranged in rows and columns,
wherein the node array comprises a root node at a corner of the node array,
wherein the root node is configured to receive a clock signal from external to the node array, to provide the clock signal to a first neighboring node in a same column of the node array with a unit of delay, and to provide the clock signal to a second neighboring node in a same row of the node array with the unit of delay, and
wherein nodes along a diagonal of the node array receive the clock signal with a same number of unit clock delays.

12. The node array of claim 11, wherein the root node comprises computing circuity, and the root node is further configured to provide the clock signal to the computing circuitry.

13. The node array of claim 11, wherein the plurality of nodes comprise a first node configured to:
receive the clock signal from two upstream nodes, and
provide the clock signal to two downstream nodes with a one unit clock delay.

14. The node array of claim 11, wherein the plurality of nodes comprise a first node comprising:
a first input clock wire configured to the clock signal from a first upstream node;
a second input clock wire configured to receive the clock signal from a second upstream node;
a first output clock wire configured to provide the clock signal to a first downstream node; and
a second output clock wire configured to provide the clock signal to a second downstream node.

15. The node array of claim 14, wherein the first node further comprises a first inverter coupled between the first input wire and a computing circuitry of the first node, the first inventor also coupled between the second input wire and the computing circuitry.

16. The node array of claim 14, wherein:
the first upstream node is located north of the first node,
the second upstream node is located west of the first node,
the first downstream node is located east of the first node, and
the second downstream node is located south of the first node.

17. The node array of claim 11, wherein the node array further comprises:
a multiplexer configured to receive a functional clock signal from a clock generation circuit and a test clock, and output one of the functional clock signal and the test clock to the root node as the clock signal.

18. The node array of claim 11, wherein the node array has a strapped H-tree clock distribution topology.

19. A method of clock distribution in a node array, comprising:
receiving a clock signal at a first node of the node array;
providing the clock signal to computing circuitry of the first node; and
providing the clock signal to a neighboring node of the node array, wherein the neighboring node abuts the first node, and wherein the clock signal has a unit of delay in the neighboring node relative to in the first node.

20. The method of claim 19, further comprising:
receiving, at the first node, the clock signal from two upstream nodes with the unit of delay relative to the two upstream nodes, wherein one of the two upstream nodes is in a same row of the node array as the first node, and wherein an other of the two upstream nodes is in a same column of the node array as the first node; and
providing the clock signal to two downstream nodes with the unit of delay relative to the first node.
